(19) United States
(12) Patent Application Publication
(10) Pub. No.: US 2022/0089830 A1
(43) Pub. Date: Mar. 24, 2022

(54) CONTINOUS LIQUEFYING SYSTEM FOR PLASTIC TREATMENT

(71) Applicant: VALGROUP S.A., Luxembourg (LU)

(72) Inventor: Lucas Salim Geronimi, Lorena (BR)

(21) Appl. No.: 17/483,963

(22) Filed: Sep. 24, 2021

Related U.S. Application Data
(60) Provisional application No. 63/082,512, filed on Sep. 24, 2020.

(51) Int. Cl. C08J 11/12; B29B 17/02

(52) U.S. Cl. CPC C08J 11/12; B29B 17/02; B29K 2067/003; C08J 2323/06; B29B 2017/0244; C08J 2367/02

(57) ABSTRACT

A continuous liquefying system for thermochemical treatment of plastic that has two different devices and complements. The devices comprise a first device, a second device, and a coupling device. In the first device, filled with water, the plastic is feed using a screw in a first port. The first device is used as a water airlock. The plastic is extracted from the first device using the coupling device having a screw, and is sent to the second device. From the first device to the second device there is a lateral screen, responsible for the retention of water. The second device has tubes filled with a heating fluid, that actuates heating the plastic material. The plastic material is liquefied and could be sent to other applications, such as thermochemical processes, thermoforming, and others.

### CROSS REFERENCE TO RELATED APPLICATIONS

This application claims the benefit of U.S. Provisional Application Ser. No. 63/082,512, filed on Sep. 24, 2020. The entire disclosure of the above application is incorporated herein by reference.

### FIELD

The present disclosure relates generally to the treatment of plastic, and more specifically, to a system for plastic recycling.

### INTRODUCTION

This section provides background information related to the present disclosure which is not necessarily prior art.

Since the production of plastics involves the utilization of natural resources, the reutilization of these materials through recycling is truly desirable. Currently, most of the consumed plastics are not recycled. An effort has been made in order to change this scenario. One of the major problems of the known methods of plastic recycling is the energy involved in the liquefaction of plastics. Methods that reducing this energy consumption are desirable. An efficient method that reduces the energy consumption during the recycling process may increase the recyclability of the materials.

It has been observed that the volume of plastic discarded each year is steadily increasing. Some kinds of plastic are easily recycled such as polyethylene terephthalate (PET) and polyethylene (PE). However, most of the consumed plastics are discharged in the landfills or are incinerated. According to Panorama dos Residuos Sólidos no Brasil 2017, in the year of 2017 in Brazil, the rate of recycling was about 8.21% of all the plastics produced in the same year. The remaining 91.79% was discharged in other ways, which are known to be contributing to the release of greenhouse gases to the environment.

Mechanical recycling is able to recycle some plastics such as PET and PE, but the majority of plastic products cannot be recycled by conventional means. These “unrecyclable” plastics are then sent to landfills or incinerators. As previously mentioned, the known processes for recycling plastics are very energy consuming. The different thermal and physical chemical properties of the wide variety of plastics makes it challenging to create an efficient plastic recycling system that is capable of accepting a wider variety of plastics. In other words, the different properties of the different plastics present technical and economic barriers to the plastics recycling industry. One of the major difficulties to plastic recycling is the step of plastic liquefaction, which is highly energy consumptive, as disclosed in GAO, F. Pyrolysis of Waste Plastic into Fuels. University of Canterbury, 2010.

Current methods for recycling PET and PE involve the complete liquefaction of these materials. However, for the plastics that are not recovered for recycling, which are the majority of plastics, there is not a suitable technology to process and liquefy them, as disclosed in Garcia, J. and Robertson, M. The Future of Plastics Recycling. Science, v. 358, issue 6365, p. 270-281, 2017.

An important characteristic of the liquefaction process is the system isolation. Since the variety of plastic materials have different melting temperatures, the process temperature should be at least the melting temperature of the highest melting temperature polymer. The system should work without oxygen in order to avoid the formation of byproducts including carbonyl, ester, acid, and other groups. It is desirable to have only a thermal degradation reaction, without the occurrence of thermal oxidation. The absence of oxygen is also essential for the security of the process. Without oxygen, the system stays protected from combustion reactions, as disclosed in JANSEN, J. Plastic Failure Through Molecular Degradation. Henkel.

There is a continuing need for a liquefaction system that is efficient and that allows for the treatment of a variety of mixed plastics. Desirably, the system should accept all kind of plastics and homogenize the end product in order to prepare the material for further thermochemical treatment, thermoforming, or other kinds of applications.

### SUMMARY

In concordance with the instant disclosure, an efficient and economical continuous liquefying system for treatment of plastic, which creates an end product that may be used in further thermochemical treatments, has been surprisingly discovered.

In particular, the present disclosure includes a continuous liquefying system for plastic treatment. The liquefying system receives shredded and cleaned plastics which are sent to a first device by a screw. This first device operates as a water airlock for the system since it does not allow for the passage of oxygen to the second device. Through a series of hermetic screws, the material is sent to the second device. Before the second device there is a corrugated tube, that is configured to militate against the plastic processing material from melting inside the screw. The second device is heated using tubes, such as a heat exchanger, filled with a heating element, which could be molten salt and/or oil, as non-limiting examples. The second device may operate under a vacuum condition in order to increase the drying and melting efficiency, and also to avoid any residual oxygen.

Further areas of applicability will become apparent from the description provided herein. It should be understood that the description and specific examples are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of the liquefaction system for plastic treatment, according to one embodiment of the present disclosure; and

FIG. 2 is a flowchart of a method for assembling the storage system, according to one embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIGS. is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

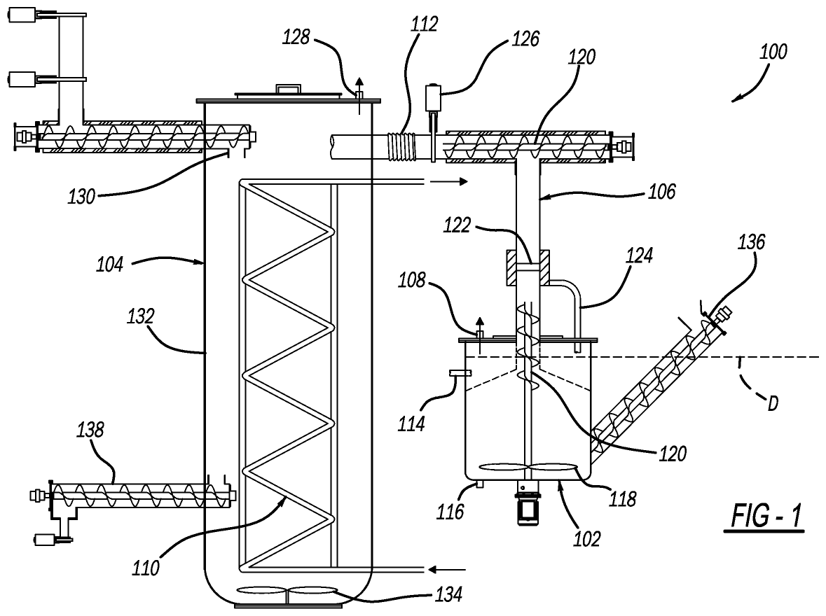

With reference to FIG. 1, a continuous liquefying system 100 for plastic treatment is shown. The continuous liquefying system 100 may be configured to melt a processing material. The processing material may include a variety of plastics intended for recycling. The continuous liquefying system 100 may include a first device 102, a second device 104, and a coupling device 106. The first device 102 may provide a first vacuum 108 configured to provide an oxygen deprived environment. The second device 104 may have a heating element 110 that is configured to melt the processing material. The coupling device 106 may couple the first device 102 to the second device 104. The coupling device 106 may also have an intermediary coupling 112 that is configured to militate against the conduction of heat.

In certain circumstances, the first device 102 may include a way to militate against oxygen from entering the coupling device 106 and/or the second device 104. For instance, the first device 102 may include a volume of a liquid, such as water, that is configured to act as an airlock or more particularly, a water airlock. The first device 102 may further be equipped with a water pump 114. The water pump 114 may be configured to maintain a level of the liquid inside the first device 102. Advantageously, by maintaining the level of liquid at a predetermined depth D within the first device 102, the level of liquid airlocks the continuous liquifying system 100.

In certain circumstances, the volume of the liquid may also be configured to clean the processing material. The first device 102 may also use the first vacuum 108 to extract any residual oxygen in the first device 102. The volume of the liquid may also be used to separate the processing material by density in the volume of liquid. In a specific example, the processing material may be separated by removing higher density processing materials from lower density processing materials. Advantageously, the processing material may be separated because polyolefins may float while other plastics and residues may sink in the first device 102. For instance, polyethylene terephthalate (PET) and polyethylene (PE) may float within the first device 102 while more dense plastics may sink within the first device 102.

In certain circumstances, as shown in FIG. 1, the first device 102 may include a way to remove more dense processing materials from the first device 102. For instance, the first device 102 may include a drain 116 configured to accept the denser processing materials and various residues. The first device 102 may also include a selectively rotatable blade 118 configured to move the denser processing materials and various residues toward the drain 116.

In certain circumstances, the first device 102 may include a mechanical transport device 120 configured to move the processing material from the first device 102 to the coupling device 106. In some instances, the mechanical transport device 120 may be provided throughout the coupling device 106. As a non-limiting example, the mechanical transport device 120 may include a hermetic screw. In a specific example, the coupling device 106 may include a plurality of hermetic screws configured to cooperatively transport the processing material from the first device 102 to the second device 104. In certain circumstances, the coupling device 106 may include a screen 122 that is configured separate the liquid from the processing material. As the processing material is transferred from the first device 102 through the coupling device 106, the processing material may possess a high-liquid content. The processing material may be fed at a rate where the processing material compresses against the screen 122. As the processing material is compressed, liquid is expelled from the processing material and the liquid exits through the screen 122. The expelled liquid may be recuperated through a pathway 124 to divert the liquid collected by the screen 122 back to the first device 102. Advantageously, the screen 122 may remove the liquid from the processing material and recycle the liquid back through the pathway 124 to the first device 102.

In certain circumstances, as shown in FIG. 1, the intermediary coupling 112 of the coupling device 106 may be configured to militate against the conduction of heat provided by the heating element 110 from the second device 104 to the first device 102. For instance, the intermediary coupling 112 may be substantially corrugated. Where the intermediary coupling 112 is substantially corrugated, the surface area of the intermediary coupling 112 is increased, thereby allowing the heat to dissipate more efficiently. Further, the coupling device 106 may be constructed from a first material and the intermediary coupling 112 may be constructed from a second material. The first material may be substantially more conductive than the second material. For instance, the first material may be constructed from a metal material and the second material may be constructed from a composite, ceramic, glass, concrete, cement, brick, and/or fiberglass, as non-limiting examples. In a specific example, the coupling device 106 may be twice as conductive as the intermediary coupling 112. In a more specific example, the coupling device 106 may be four times as conductive as the intermediary coupling 112. In an even more specific example, the coupling device 106 may be substantially more conductive than the intermediary coupling 112 where the coupling device 106 is ten times as conductive as the intermediary coupling 112. As a non-limiting example, the coupling device 106 may be constructed from copper having 413 W/(mK), also known as Watts per meter-Kelvin, at 25 degrees Celsius and the intermediary coupling 112 may be constructed from glass having 1 W/(mK) at degrees Celsius. Advantageously, the intermediary coupling 112 may militate against the processing material from undesirably melting within the coupling device 106.

In certain circumstances, as shown in FIG. 1, the coupling device 106 may include a valve 126 that is configured to selectively obstruct the coupling device 106 between the first device 102 and the second device 104. Advantageously, the valve 126 may isolate the first device 102 from the second device 104 and/or the second device 104 from the first device 102. Desirably, the isolation between the first device 102 and the second device 104 may militate against the spread of an undesirable reaction, such as an oxidative reaction, within the continuous liquefying system 100.

In certain circumstances, as shown in FIG. 1, the second device 104 may include a second vacuum 128. The second vacuum 128 may be used to deplete the second device 104 of residual oxygen. Advantageously, the first vacuum 108 and the second vacuum 128 may militate against an oxidative reaction from occurring within the continuous liquefying system 100. Desirably, the vacuum condition throughout the continuous liquifying system 100 increases the drying and melting efficiency.

In certain circumstances, with continued reference to FIG. 1, the second device 104 may permit additives to be added to the processing material. For instance, the second device 104 has an opening 130 to selectively insert additives into the second device 104. As a non-limiting example, additives such as virgin polymers and masterbatches, may be inserted into the second device 104, according to a desired application.

In certain circumstances, as shown in FIG. 1, the heating element 110 may evenly heat a sidewall 132 of the second device 104. For instance, the heating element 110 of the second device 104 may extend vertically along the sidewall 132 of the second device 104. In a specific example, the heating element 110 may coil around the sidewall 132 or may be disposed in a zig-zag pattern around the sidewall 132. Advantageously, the heating element 110 may more evenly heat the second device 104 where the heating element 110 extends vertically along the sidewall 132.

In certain circumstances, the heating element 110 may be configured to enhance the efficiency of heating the second device 104. For instance, the heating element 110 may include molten salt. Advantageously, the molten salt may require less energy to heat and may conserve the heat more efficiently compared to other common heating substances, such as oil.

In certain circumstances, as shown in FIG. 1, the second device 104 may include a way to selectively homogenize the processing material. For instance, the second device 104 may include an agitation system 134 that is configured to mix the liquified processing material. Advantageously, where the second device 104 homogenizes the processing material, the processing material may be used in more thermoplastic applications such as thermochemical processes and thermoforming, thereby increasing the options for recycling plastics. Desirably, by homogenizing the processing material, the agitation system 134 may increase the stability of processing material and accelerate the heat transfer between the processing materials. Examples of agitation systems 134 include various mechanical agitators, such as a rotating blade or another moveable member configured to mix the processing material as it transitions to a liquefied state.

In certain circumstances, the processing material may be fed into the first device 102 through a first port 136. The processing material may be extracted from the second device 104 through a second port 138. Each of the first port 136 and the second port 138 may also include the mechanical transport device 120. The first port 136 may also be filled to the predetermined depth D of the liquid to further airlock the first device 102.

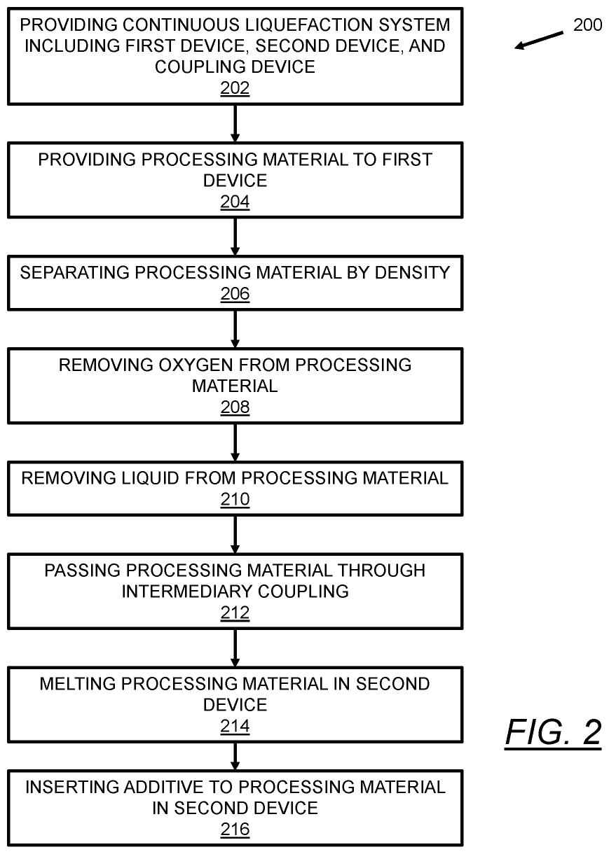

As shown in FIG. 2, the present technology can include a first method 200 for processing the processing material in the continuous liquefying system 100. The first method 200 may include a step 202 of providing a continuous liquefaction system 100 including a first device 102, a second device 104, and a coupling device 106. The first device 102 may have a first vacuum 108. The second device 104 may have a heating element 110 that is configured to melt the processing material. The coupling device 106 may couple the first device 102 to the second device 104. The coupling device 106 may have an intermediary coupling 112 that is configured to militate against the conduction of heat. In certain circumstances, the second device 104 and the coupling device 106 may be oxygen deprived. Next, the method 200 may include a step 204 of providing the processing material to the first device 102. Then, oxygen may be removed from the processing material. In another step 208, a liquid may be removed from the processing material. Next, the processing material may pass through the intermediary coupling 112. Afterwards, the processing material may be melted in the second device 104. The method 200 may also include separating the processing material by density. In certain circumstances, the method 200 may include inserting an additive into the second device 104.

Advantageously, the continuous liquifying system 100 may more efficiently and more economically treat plastic for recycling. Desirably, the processing material may be melted, homogenized, and treated with predetermined additives to make the processing material more usable for a greater number of recycled applications.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A continuous liquefying system configured to melt a processing material, comprising:
a first device configured to provide an oxygen deprived environment;
a second device having a heating element configured to melt the processing material; and
a coupling device that couples the first device to the second device, the coupling device having an intermediary coupling configured to militate against the conduction of heat.

2. The continuous liquefying system of claim 1, wherein the first device includes a first vacuum and a volume of a liquid that are configured to act as an airlock.

3. The continuous liquefying system of claim 2, wherein the first device is configured to separate the processing material by density in the volume of liquid.

4. The continuous liquefying system of claim 1, wherein the first device includes a mechanical transport device configured to move the processing material from the first device to the coupling device.

5. The continuous liquefying system of claim 1, wherein the first device includes a selectively rotatable blade.

6. The continuous liquefying system of claim 2, wherein the coupling device has a screen configured separate the liquid from the processing material.

7. The continuous liquefying system of claim 6, wherein the coupling device includes a pathway to divert the liquid back to the first device when the liquid is separated from the processing material.

8. The continuous liquefying system of claim 1, wherein the intermediary coupling is substantially corrugated.

9. The continuous liquefying system of claim 1, wherein the coupling device is constructed from a first material and the intermediary coupling is constructed from a second material, and the first material is substantially more thermally conductive than the second material.

10. The continuous liquefying system of claim 1, wherein the coupling device includes a valve configured to selectively obstruct the coupling device between the first device and the second device.

11. The continuous liquefying system of claim 1, wherein the second device has an opening to selectively insert additives into the second device.

12. The continuous liquefying system of claim 1, wherein the second device has a second vacuum.

13. The continuous liquefying system of claim 1, wherein the heating element of the second device extends vertically along a sidewall of the second device.

14. The continuous liquefying system of claim 11, wherein the heating element includes molten salt.

15. The continuous liquefying system of claim 1, wherein the second device may further include an agitation system configured to selectively homogenize the processing material.

16. A continuous liquefying system configured to melt a processing material, comprising:
a first device configured to provide an oxygen deprived environment;
a second device having a heating element configured to melt the processing material;
a coupling device that couples the first device to the second device, the coupling device having an intermediary coupling configured to militate against the conduction of heat;
wherein:
the first device includes a first vacuum and a volume of a liquid that are configured to act as an airlock;
the first device is configured to separate the processing material by density in the volume of liquid;
the first device includes a mechanical transport device configured to move the processing material from the first device to the coupling device;
the first device includes a selectively rotatable blade;
the coupling device has a screen configured separate the liquid from the processing material;
the coupling device includes a pathway to divert the liquid back to the first device when the liquid is separated from the processing material;
the intermediary coupling is substantially corrugated;
the coupling device is constructed from a first material and the intermediary coupling constructed from a second material, and the first material is substantially more thermally conductive than the second material;
the coupling device includes a valve configured to selectively obstruct the coupling device between the first device and the second device;
the second device has an opening to selectively insert additives into the second device;
the second device has a second vacuum;
the heating element of the second device extends vertically along a sidewall of the second device;
the heating element includes molten salt; and
the second device may further include an agitation system configured to selectively homogenize the processing material.

17. A method of processing a processing material in a continuous liquefying system, comprising:
providing a continuous liquefying system including:
a first device configured to provide an oxygen deprived environment;
a second device having a heating element configured to melt the processing material; and
a coupling device that couples the first device to the second device, the coupling device having an intermediary coupling configured to militate against the conduction of heat;
providing the processing material to the first device;
removing oxygen from the processing material;
passing the processing material through the intermediary coupling; and
melting the processing material in the second device.

18. The method of claim 17, wherein the first device includes a first vacuum and a volume of a liquid that are configured to act as an airlock, the coupling device has a screen configured separate the liquid from the processing material, and the method further comprises removing liquid from the processing material prior to passing the processing material through the intermediary coupling.

19. The method of claim 18, further comprising a step of separating the processing material by density.

20. The method of claim 17, wherein the second device and the coupling device are oxygen deprived.
